(19) United States
(12) Patent Application Publication
(10) Pub. No.: US 2018/0121773 A1
(43) Pub. Date: May 3, 2018

(54) RFID TAG AND METHODS OF USE AND MANUFACTURE AND RFID MONITORING CABINET AND SMART PHONE CASE AND METHODS OF USE

(71) Applicant: Smarthin Technologies, Inc., Milpitas, CA (US)

(72) Inventor: MARTIN TERCSINECZ, ESZTERGOM (HU)

(73) Assignee: Smarthin Technologies, Inc., Milpitas, CA (US)

(21) Appl. No.: 15/856,416

(22) Filed: Dec. 28, 2017

Related U.S. Application Data
(63) Continuation-in-part of application No. 15/342,779, filed on Nov. 3, 2016, now Pat. No. 9,886,661.

(51) Int. Cl. G06K 17/00; G06K 7/10; G06K 19/02; G06K 19/077; G06K 19/07

(52) U.S. Cl. CPC G06K 17/0029; G06K 7/10297; G06K 7/10425; G06K 19/0702; G06K 19/07775; G06K 19/07786; G06K 19/022

(57) ABSTRACT

A smart phone carrier comprising an electrical panel on flexible foil with UHF RFID reader module, Bluetooth communication controller connected by silver conductive ink for reading thin RFID (Radio Frequency Identification) tags, including but not limited to those manufactured as described herein, and communicating location, tracking, and monitoring to a smart phone or network of smartphones. A smart RFID cabinet with controlling unit comprising a controlling computer having memory comprising connected shelves in electronic communication made of glass fiber coated with a carbon alloy material with integrated RFID antennas on each shelf to locate, track and monitor RFID tags with or without regard to a specific shelf for a wide variety of applications, including being attached, affixed to, woven in, or otherwise enclosed within clothing, scrubs, towels, linen, consumer products, office supplies, food products, and other goods and inventory.

### CROSS REFERENCE TO RELATED APPLICATION

This application is a continuation-in-part of U.S. patent application Ser. No. 15/342,779, filed Nov. 3, 2016.

### FIELD OF THE INVENTION

RFID, or Radio Frequency Identification, is a technology where information stored on a microchip can be read remotely, without physical contact using energy in the RF spectrum. An RFID system consists of a reader, or interrogator, which emits an RF signal via an antenna. The microchip receives energy via an attached antenna (termed an RFID tag) and varies the electromagnetic response its antenna in such a way that information can be transferred to the reader.

The present invention relates to RFID devices and their manufacture and use, and in particular, to RFID (Radio Frequency Identification) tags that are waterproof, made of materials able to withstand high pressure, hot and cold temperatures, and durable enough be used in a wide variety of applications, including being attached, affixed to, woven in, or otherwise enclosed within clothing, towels, linen, or other laundry that is washed in washing machines, or affixed to other products, including consumer products, food products, and other goods and inventory. Such tags are capable of reuse in certain applications.

Information stored on such RFID tags can be read using mobile UHF readers or a smartphones using RFID or Bluetooth or other forms of wireless communication known to those skilled in the art. Alternatively, such tags can be read with gate readers designed for use in retail or industrial environments known to those skilled in the art. The tags also can be used as a security or monitoring device or as a way of expediting calculating purchase prices of goods at checkout stations.

RFID tags must be designed to be durable. Such tags may be attached to sheets or towels, table napkins, hand towels used commercially used at hotels, gyms, and restaurants. Commercial sheets, towels, and napkins are used and washed over and over, typically in bulk at large scale, industrial laundry service providers, where they are washed together.

When extracting water from laundry, such as sheets, after washing the laundry with water, for example, the laundry service provider sometimes puts a large amount of laundry in a huge container and extracts water from the laundry by pressing the laundry with a huge piston from above the container in order to enhance washing efficiency. RFID tags attached to the laundry can sometimes be damaged by a breakage in connecting portions between the IC chip and the circuit part and the circuit itself. Such tags may also be attached to paper boxes, foils, metals, parts, plastics, wooden products, glass and any consistent materials and also need to be able to withstand potential damage and breakage in those applications.

The present invention also relates to a monitoring cabinet that can be used with the RFID tags described herein or other RFID tags of different design, as well as a charging case for a smart phone equipped with an RFID reader that can detect in real time the RFID tags described herein or other RFID tags.

### BACKGROUND

There are known, prior art designs and methods of manufacture for RFID tags. For example, U.S. Pat. No. 9,064,199 (Nitta) describes a flexible RFID tag design with a continuous body that includes an RFID antenna that is close to the flexible material. The RFID antenna tag base itself is made of a flexible material. The antenna is configured as a conductive thread.

The tag base is attachable to a flexible material product and has an RFID inlay or module provided for the tag base, having an IC chip and an RFID antenna, and capable of performing wireless data communication. The tag base is comprised of a flexible material, and the RFID antenna includes a base antenna portion configured by integrating a conductive thread into the tag base, including by weaving or sewing. The RFID inlay or module may include: the IC chip; an inlay antenna portion connected to the IC chip; and a protecting member configured to protect the inlay antenna portion and the IC chip.

Other approaches also use conductive thread antennas of different shapes with epoxy resin. The conductive thread approaches result in tags with antennas that are more susceptible to breaking easily. Tags made with conductive thread typically require larger tag sizes due to the relatively greater thickness of the conductive thread. The larger tag sizes required with a conductive thread approach can damage clothing, laundry or other materials in which the tags are used.

Still other prior art approaches construct the antenna from milled foil of aluminum glued on the top of the substrate and do not use epoxy resin to strengthen connection of the platform of the chip and the connection points of antenna. Tags made using these approaches are more susceptible to damage at the connection portions between the antennas and integrated circuit.

There are prior art approaches that use silver conductive ink to print the antenna onto the surface of the substrate using a stencil printing process to provide the conductive ink on the substrate. With this approach, shapes are milled from the substrate using a stencil knife tool. But multiple layers of conductive ink cannot be applied on the same surface. This affects the reading distance and accuracy of the resulting tags.

Another approach using conductive ink for the antenna prints the ink from a jet ink printer as is described in U.S. Pat. No. 8,922,435. These approaches do not enable multiple layers of ink to be printed on the same surface which adversely affects the quality of the tag and its ability to be read in terms of accuracy and distance. Yet another approach is described in U.S. Pat. Pub. No. 2007/007344 (Inoue et al.), in which the antenna is formed using conductive paste, which has a high resistance and also results in inferior performance.

What is needed is a design for an RFID tag that is thin, flexible, durable, capable of being used and reused in a wide variety of applications, including applications where the tags are subject to water, extreme hot and cold temperatures, and other stresses which can damage or break the tags, able to be read efficiently, quickly, and in bulk using a wide variety of readers, yet be able to be produced efficiently and at a lower cost than prior art designs and methods of manufacture. The present invention achieves these advantages without the drawbacks and problems of prior art designs and provides improved performance in reading accuracy, distance, and speed.

What is also needed are improved applications for monitoring and tracking RFID tags, including the smart phone case with RFID reading capability and smart RFID cabinet described below.

### SUMMARY OF THE INVENTION

As described in detail herein below, the devices and methods of manufacture and production described herein employ a novel design for a thin RFID tag and methods of production and manufacture that combine durability and effectiveness for a wide variety of applications and achieve significant cost savings over prior art approaches and provides advantageous durability and performance using a wide variety of readers.

The design includes printing at least one antenna (and preferably two) on a substrate carrier foil. The antenna is preferably needle shaped and printed using a printing technology that enables multiple layers of a conductive ink solution to be printed on the same surface that dry faster and result in improved reading performance. When one antenna is used, two resonance amplifiers are necessary. When two antennas are used, they can be symmetrically offset across a longitudinal centerline at at least four offset points and four resonance amplifiers are necessary. The four resonance amplifiers are printed on the substrate carrier at the offset points and a UHF RFID circuit integrated into the first substrate carrier at the at least four offset points.

Despite the dense texture, the conductive ink solution ink is easily applicable on the resin due to the using of a high resolution screen canvas. The antennas remain flexible after drying and become more durable than the RFID tags of other companies. The inventive conductive ink solution can be applied to textile and the foil substrates described herein to enhance the functioning of the thin, RFID tag as described herein.

In accordance with a first aspect of the invention an RFID tag is provided comprising a first substrate comprising a flexible waterproof material and configured to include a substrate carrier foil comprising at least a first antenna printed on the substrate carrier foil from a conductive ink liquid solution; at least a first and second resonance amplifier printed on the substrate carrier foil and connected to the at least one antenna; a UHF RFID circuit integrated into the first substrate carrier foil at the at least one antenna; and a second substrate carrier configured to cover the first substrate carrier and the UHF RFID circuit, wherein the substrate carrier foil comprises kapton and the first antenna has a length of 5 to 255 mm, a width of and 0.005 to 5 mm in width, and a thickness of 0.05 to 9 mm.

In another embodiment, the substrate carrier foil comprises ST505 PET polymide. In another embodiment, the substrate carrier foil comprises polyester. In another embodiment, the substrate carrier foil further comprises kapton laminate.

In another embodiment, the tag further comprises a second antenna printed on the substrate carrier foil from the conductive ink solution, wherein the second antenna has a length of 5 to 255 mm, a width of and 0.005 to 5 mm in width, and a thickness of 0.05 to 9 mm. In other embodiments, the antennas are needle shaped.

In another embodiment, the tag further comprises a second antenna printed on the substrate carrier foil from the conductive ink solution, wherein the second antenna has a length of 5 to 255 mm, a width of and 0.005 to 5 mm in width, and a thickness of 0.05 to 9 mm and the first antenna and the second antenna are symmetrically offset across a longitudinal centerline at at least four offset points, further comprising third and fourth resonance amplifiers, wherein the third and fourth resonance amplifiers are printed on the substrate carrier foil at two of the four offset points.

In another embodiment, the conductive ink solution comprises 65-75% DuPont e782 Silver ink, 15-25% graphite, and 5-15% neodymium.

In another embodiment, the tag is configured to read at least 150 tags per second at a range of up to 4 meters with a mobile UHF reader or at least 950 tags per second at a distance of up to 10 meters using a gate reader.

In accordance with a second aspect of the invention, a method of manufacturing an RFID tag is provided comprising loading rolled foil in a feeding unit; unrolling the foil to a printer unit comprising a squeegee and press screen having holes; passing the unrolled foil underneath the press screen; moving the squeegee of the printing unit back and forth over the press screen to dispense a preset amount of conductive ink solution at a preset pressure on the foil through the press screen to create at least one needle shaped antenna on the foil of 5-255 mm in length, 0.05-5 mm in width, and a thickness of 0.05-0.9 nm; passing the unrolled foil to a drying unit; subjecting the unrolled foil to heat in at least two heating units to dry the at least two needle shaped antennas on the foil; loading the unrolled foil in a bonding unit; dispensing epoxy resin from the bonding to the unrolled foil; mounting an ultra-high frequency (UHF) RFID integrated circuit to the unrolled foil with the epoxy resin at at least two points of the at first antenna; mounting at least two resonance amplifiers to the unrolled foil at at least two points of the antenna; placing the foil in a first, flexible, waterproof substrate carrier and covering and sealing the first substrate carrier with second substrate carrier configured to cover the first substrate carrier and the UHF RFID circuit.

In another embodiment, wherein the unrolled foil comprises kapton

In another embodiment, the unrolled foil comprises ST505 PET polymide. In another embodiment, the unrolled foil further comprises polyester. In another embodiment, the unrolled foil further comprises kapton laminate. In another embodiment, the conductive ink solution comprises DuPont e782 Silver ink.

In another embodiment, wherein the conductive ink solution comprises 65-75% DuPont e782 Silver ink, 15-25% graphite, and 5-15% neodymium.

In another embodiment, the method further comprises further comprising moving the squeegee of the printing unit back and forth over the press screen to dispense a preset amount of conductive ink solution at a preset pressure on the foil through the press screen to create a second antenna on the foil of 5-255 mm in length, 0.05-5 mm in width, and a thickness of 0.05-0.9 nm; and mounting a third and fourth resonance amplifiers to the unrolled foil at at least two points of the second antenna.

In another embodiment, the preset pressure is 1-3 bar. In another embodiment, the preset amount of conductive ink is 195-205 ml.

In another aspect, a smart phone charging case comprising an electrical panel installed on a flexible foil, the electrical panel comprising a Bluetooth radio communication controller, RFID reader module, UHF flexible RFID antenna, port to receive and charge a mobile phone, and battery, wherein the Bluetooth radio controller, the RFID reader module, the UHF flexible RFID antenna, and battery are connected using conductive ink.

In another embodiment, the smart phone charging case is configured and programmed to track, monitor, or locate in real time the RFID tags and items with RFID tags embedded or otherwise attached, including towels, uniforms, clothing items, scrubs, or office supplies and communicate tracking, monitoring, or location information for the RFID tags and items with RFID tags embedded or otherwise attached to a computer or smartphone.

In another embodiment, the smart phone charging case reads the RFID tags or the items with RFID tags embedded or otherwise attached located within a distance of 3 meters or less of the smart phone case.

In another embodiment, the smart phone charging case is configured and programmed to communicate the location, monitoring, and tracking data for the RFID tags or the items with RFID tags embedded or otherwise attached to a smart phone connected to the smart phone case.

In another embodiment, the smart phone case is a first smart phone charging case configured and programmed to be connected and linked with one or more additional smart phone charging cases each comprising an electrical panel installed on a flexible foil, the electrical panel comprising a Bluetooth radio controller; RFID reader module; UHF flexible RFID antenna; port to receive and charge a smartphone configured and programmed to locate, monitor, and track in real time RFID tags and items with RFID tags embedded or otherwise attached, including towels, uniforms, clothing items, scrubs, and office supplies; and a battery, wherein the additional smartphone charging cases are configured and programmed to locate, monitor, and track in real time RFID tags and items with RFID tags embedded or otherwise attached connected to the additional smart phone cases, including towels, uniforms, clothing items, scrubs, and office supplies, paired with the additional smart phone cases, and the first smart phone case is configured and programmed to locate, monitor and track the RFID tags and items with RFID tags embedded or otherwise attached, connected to or paired with either the first smart phone case, the additional smart phone cases, or both the first smart phone case, and the additional smart phone cases.

In another aspect, a method of tracking, locating, or monitoring RFID tags and items with RFID tags embedded or otherwise attached is provided comprising providing a smart phone charging case comprising an electrical panel installed on a flexible foil, the electrical panel comprising a Bluetooth radio communication controller, RFID reader module, UHF flexible RFID antenna, port to receive and charge a mobile phone, and battery, wherein the Bluetooth radio controller, the RFID reader module, the UHF flexible RFID antenna, and battery are connected using conductive ink; using the smart phone charging case to track, monitor, or locate RFID tags and items with RFID tags embedded or otherwise attached; using the smartphone charging case to track, monitor, or locate RFID tags or items with RFID tags embedded or otherwise attached; and communicating tracking, monitoring, or location information for the RFID tags or RFID tags and the items with RFID tags embedded or otherwise attached from the smart phone charging case to a computer or a smartphone.

In another aspect, a cabinet is provided comprising a controlling unit comprising a controlling computer having memory; two or more shelves in electronic communication connected by a top surface and bottom surface; and a lithium battery, wherein each of the shelves comprise glass fiber coated with carbon alloy material and have integrated RFID antennas, wherein the integrated antennas and the controlling computer are configured, paired, or connected with RFID tags or items with RFID tags embedded or otherwise attached located on the shelves, wherein the cabinet is configured or programmed to track, monitor, or locate the RFID tags or the items with RFID tags embedded or otherwise attached located on the shelves and communicate tracking, monitoring, or location information for the RFID tags or items with RFID tags embedded or otherwise attached to a computer or smartphone.

In another embodiment, the top surface and the bottom surface comprise metal and the RFID tags or items with RFID tags embedded or otherwise attached are located on the shelves and the cabinet is configured and programmed to locate, monitor and track in real time when the RFID tags or items with RFID tags embedded or otherwise attached are removed from a specific shelf and returned to the specific shelf.

In another embodiment, the cabinet is configured and programmed to locate, monitor and track in real time when the RFID tags or items with RFID tags embedded or otherwise attached are RFID tags or items with RFID tags embedded or otherwise attached are removed from any shelf in the cabinet and returned to any of the shelves in the cabinet.

In another embodiment, the cabinet is configured and programmed so that presence or absence of the RFID tags or the items with RFID tags embedded or otherwise attached on shelves other than the specific shelf do not interfere with or affect locate, monitoring and tracking in real time when the RFID tags or items with RFID tags embedded or otherwise attached are removed from the specific shelf and returned to the specific shelf.

In another embodiment, the cabinet is configured and programmed so that the presence or absence of the RFID tags or the items with RFID tags embedded or otherwise attached on shelves other than the specific shelf do not interfere with or affect locating, monitoring and tracking in real time when the RFID tags or items with RFID tags embedded or otherwise attached are removed from any shelf in the cabinet and returned to any of the shelves in the cabinet.

In other embodiments, the cabinet further comprises one or more doors and an ID reader, where the doors comprise aluminum or inox steel and remain closed unless the RFID reader is presented with a card or code configured or programmed to open the one or more doors.

In another embodiment, the cabinet further comprises a monitor in electronic communication with the cabinet and any RFID tags or items having RFID tags attached or embedded that are stored in the cabinet and presents on the monitor tracking, monitoring or location information on the RFID tags or items having RFID tags attached or embedded that are stored in the cabinet and stores the tracking, monitoring, or location information in the controlling unit computer memory.

In another aspect, a method of locating, tracking, and monitoring RFID tags or items with RFID tags embedded or otherwise attached comprising placing RFID tags or items with RFID tags embedded or otherwise attached, including towels, uniforms, clothing items, scrubs, and office supplies on a shelf of a cabinet comprising a controlling unit comprising a controlling computer, two or more shelves in electronic communication connected by a top surface and bottom surface, and a high performance lithium battery, wherein each of the shelves comprise glass fiber coated with carbon alloy material and integrated RFID antennas; pairing or connecting the RFID tags or items with RFID tags embedded or otherwise attached with the controlling computer of the cabinet; locating, monitoring or tracking the RFID tags or items with RFID tags embedded or otherwise attached with the cabinet; storing location, monitoring, or tracking information for the RFID tags or items with RFID tags embedded or otherwise attached in memory; and communicating the location, monitoring, or tracking information to a computer, smartphone, or a monitor of the cabinet.

In other embodiments, the smart phone cases and cabinets described above are combined with specific RFID tag embodiments.

Several aspects and embodiments have been shown and described in accordance with the present invention. It should be understood that the above description is intended to be illustrative. Many other embodiments will be apparent to those of skill in the art upon reading and understanding the above description. The invention is not so limited and is susceptible of numerous changes and modifications as known to those skilled in the art and intend to cover all such changes and modifications as are encompassed by the scope of the appended claims, along with the full scope of equivalents to which such claims are entitled.

### BRIEF DESCRIPTION OF THE DRAWINGS

FIG. 1 depicts a top view of a RFID tag according to one aspect of the invention.

FIG. 2 depicts a side, cross-sectional view of an RFID tag according to one aspect of the invention.

FIG. 3 is a flow chart describing steps for manufacturing an RFID tag according to one aspect of the invention.

FIG. 4 depicts a foil loading unit used to manufacture an RFID tag according to one aspect of the invention.

FIG. 5A depicts a printer unit used to dispense a conductive ink solution and print antennas in manufacturing an RFID tag according to one aspect of the invention.

FIG. 5B depicts the printer head unit of the printing unit of FIG. 5A in greater detail.

FIG. 6 depicts a multi-chamber dryer unit used in the process of manufacturing an RFID tag according to one aspect of the invention.

FIG. 7 depicts the bonding process used to manufacture an RFID tag according to one aspect of the invention.

FIG. 8 depicts a schematic view of an electrical panel of a smart phone case with an RFID tag reader according to one aspect of the invention.

FIG. 9 depicts a hollowed out perspective view of the smart phone case and UHF RFID antenna depicted in FIG. 8.

FIG. 10 depicts a smart RFID cabinet according to one aspect of the invention.

### DETAILED DESCRIPTION

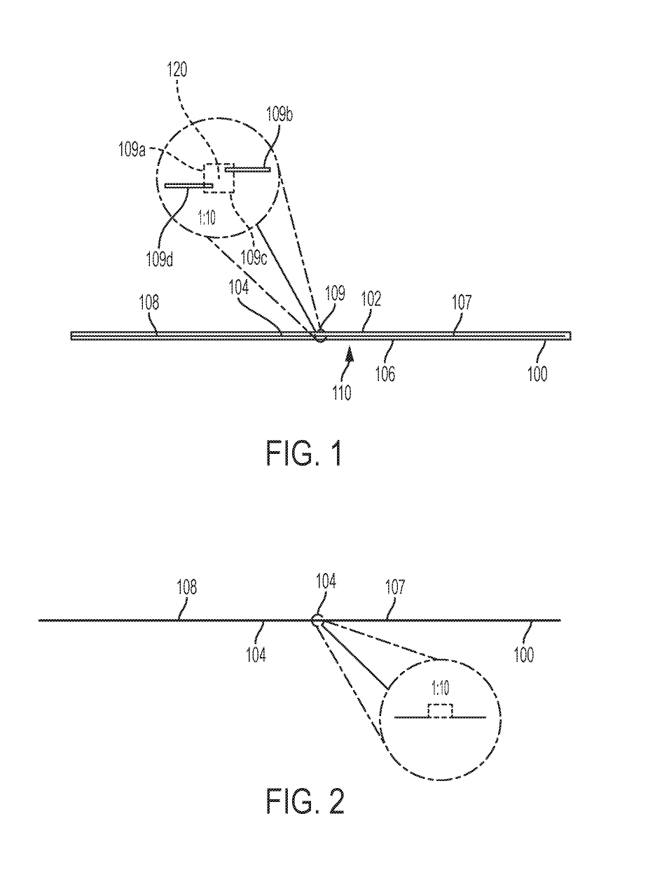

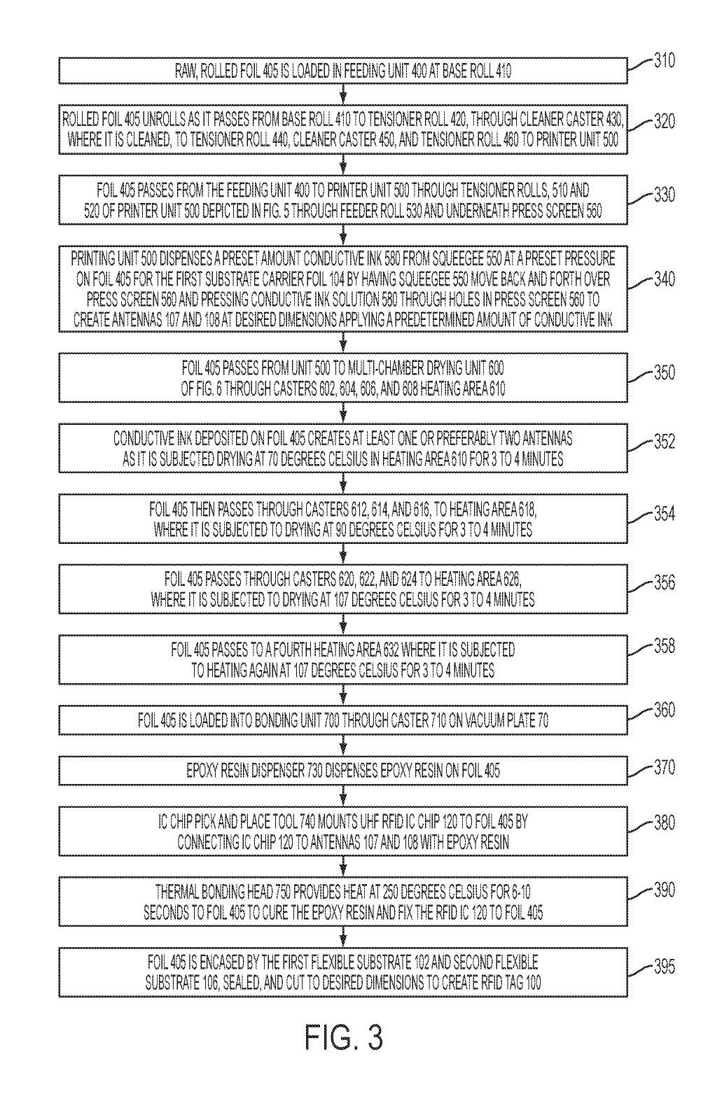

FIGS. 1 and 2 depict a top and side view of RFID tag 100, with a first flexible substrate 102 and second flexible 106 substrate. The first flexible substrate 102 and second flexible substrate 106 are preferably made from a flexible, waterproof material. Suitable materials for the first flexible substrate 102 and second flexible substrate 106 include kapton, polyethylene terephthalate (PET) polymide, textile, paper, and even human or animal skin. Dimensions for the first flexible substrate 102 and second flexible substrate 106 are preferably 155 nm (nanometers) in length each, with a width of 2 mm and thickness of 0.2 mm, but can be made to be 5 to 255 nm in length, 2 to 100 mm in width, and with a thickness of 0.2 to 2 mm. The first substrate 102 houses a first substrate carrier foil 104. The first substrate foil carrier 104 preferably has two preferably needle shaped antennas 107 and 108 printed thereon from a conductive ink solution. The two needle shaped antennas 107 and 108 are preferably symmetrically offset across a longitudinal centerline, but they do not need to be symmetrically offset. The two antennas are connected to a Ultra High Frequency (UHF) RFID integrated circuit 109 at four offset points 109a, 109b, 109c, and 109d. There are also preferably four resonance amplifiers (not pictured) printed on the first substrate carrier foil at the at four offset points 109a, 109b, 109c, 109d. The two needle shaped antennas are 5 to 255 mm in length, and preferably 75 mm in length, 0.005 mm to 5 mm in width, and preferably 0.05 mm in width.

Alternatively, a single antenna can be used of 5 to 255 nm in length, and preferably 75 nm in length, 0.005 to 5 nm in width and preferably 0.005 nm in width, with a thickness of 0.05-0.9 nm. The single antenna configuration requires at least two resonance amplifiers printed on the substrate at each end of the antenna.

The substrate carrier foil 104 is preferably made of ST 505 PET polymide, polyester, or kapton, or a combination ST 505PET polymide and kapton laminate. Other suitable materials include textile, paper, and human and animal skin.

The second flexible substrate carrier 106 is configured to cover the first substrate carrier 102 and the UHF RFID circuit connected to the substrate carrier foil 104.

The conductive ink solution bused to create antennas comprises 65-75% DuPont e782 Silver ink, 15-25% graphite, and 5-15% neodymium. Preferably, the conductive ink solution comprises 70% DuPont e782 Silver ink, 20% graphite, and 10% neodymium. Using the conductive ink solution offers significant advantages over prior art designs which use conductive thread to create antennas. Those advantages include the ability to create smaller and thinner tags that are less susceptible to breaking, that include antennas created form more than one layer of conductive material on the substrate, which in turn enables enhanced reading performance.

The preferred dimensions of RFID tag 100 are 2.00 mm in thickness with a length of 150 mm. Other feasible dimensions include a length of 5 to 255 nm, width of 2-100 mm, and thickness of 0.2-2 mm.

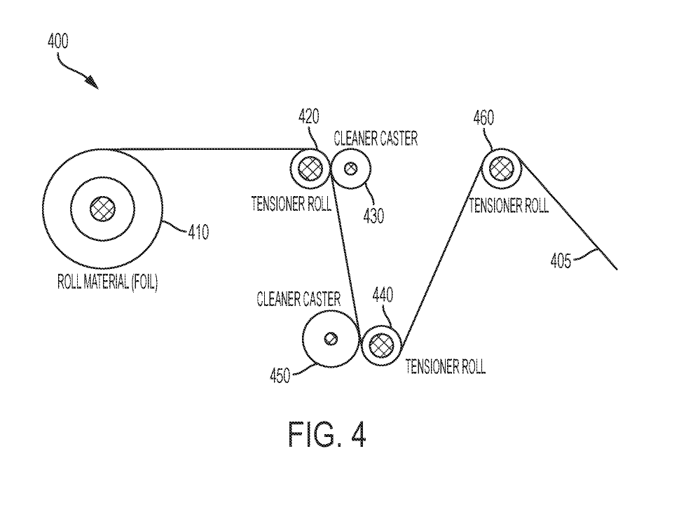

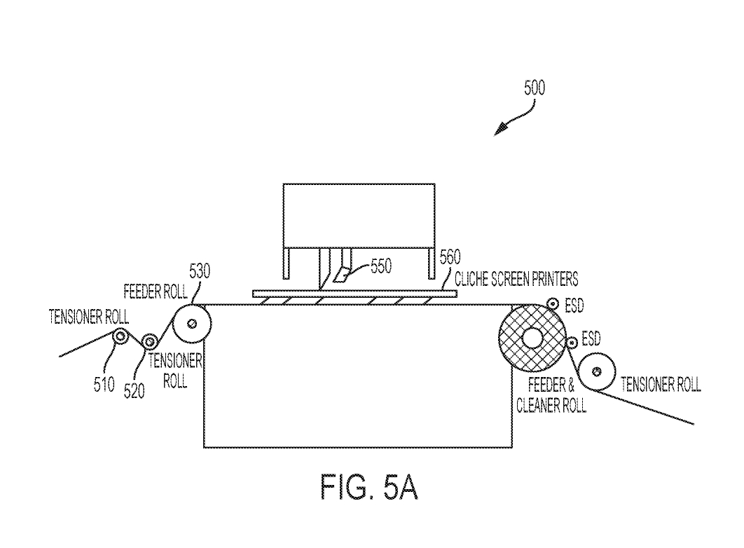

FIG. 3. is a flow chart that describes the steps for manufacturing RFID tag 100. At step 310, raw, rolled foil is loaded in feeding unit 400 depicted in FIG. 4 at base roll 410. The dimensions of the roiled foil 410 are preferably. The rolled foil is used for the first foil substrate 10.

At step 320, the rolled foil 405 unrolls as it passes from base roll 410 to tensioner roll 420, through cleaner caster 430, where it is cleaned, to tensioner roll 440, cleaner caster 450, and tensioner roll 460 to printer unit 500. The cleaning process ensures an antistatic environment. If dust is applied to the substrates prior to or during the printing process, it may cause defects in the resulting tag or affect the performance of the resulting tag.

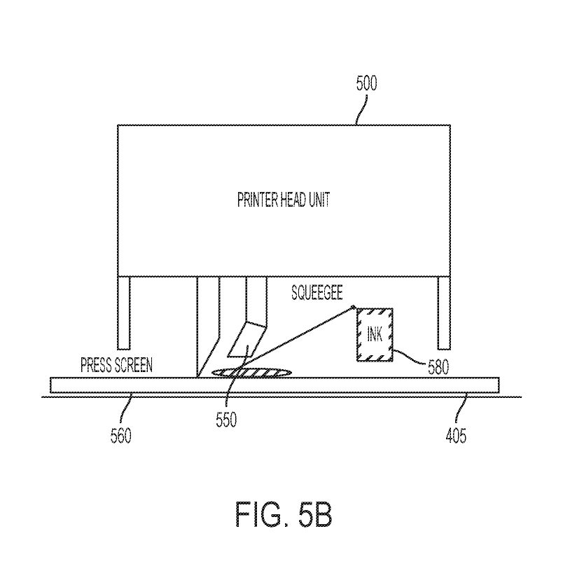

At step 330, the foil 405 passes from the feeding unit 400 of FIG. 4 to printer unit 500 depicted in FIGS. 5A and 5B through tensioner rolls, 510 and 520 of printer unit 500 depicted in FIG. 5A through feeder roll 530 and underneath press screen 560. The feeding unit 400 is preferably integrated with printing unit 500, but the units can be separated.

At step 340, printing unit 500 dispenses a preset amount conductive ink 580 from squeegee 550 at a preset pressure of 1 to 3 bar, and preferably 2 bar, on foil 405 for the first substrate carrier foil 104 by having squeegee 550 move back and forth over press screen 560 and pressing conductive ink solution 580 through holes in press screen 560 to create antennas 107 and 108 as depicted in FIGS. 1 and 2 at desired dimensions applying approximately 195 to 205 ml of conductive ink per antenna. The press screen has a high resolution of 155 to 165, and preferably 160 micron/cm². This process allows for printing of multiple layers on the same substrate to form the antenna, which is believed to result in enhanced durability and reading performance.

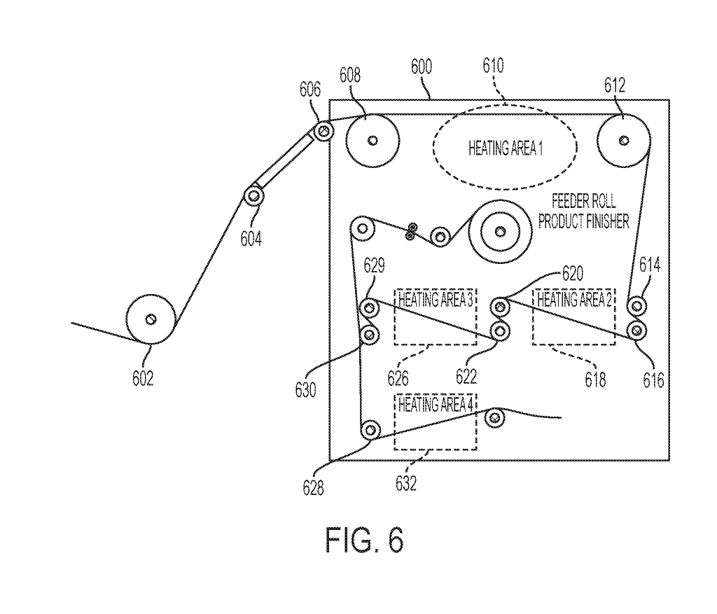

At step 350, the foil 405 passes from unit 500 to multi-chamber drying unit 600 of FIG. 6 through casters 602, 604, 606, and 608 heating area 610. The printing unit 500, is preferably integrated with the feeding unit 400, printing unit 500, and multi-chamber drying unit 600, but the units can be separated. The foil 405 is to be used for the first substrate carrier foil 104. At step 352, the conductive ink deposited on foil 405 creates at least one or preferably two antennas as it is subjected drying at 70 degrees Celsius in heating area 610 for 3-4, and preferably 3.75 minutes. At step 354, foil 405 then passes through casters 612, 614, and 616, to heating area 618, where it is subjected to drying at 90 degrees Celsius for 3-4, and preferably 3.75 minutes. At step 356, foil 405 passes through casters 620, 622, and 624 to heating area 626, where it is subjected to drying at 107 degrees Celsius for 3-4, and preferably 3.75 minutes. At step 358, foil 405 passes from casters 629 and 630 to a fourth heating area 632 where it is subjected to heating again at 107 degrees Celsius for 3-4, and preferably 3.75 minutes.

The above drying step is described using four heating areas, but other variations may be able to be used, such as using fewer heating areas at different temperatures.

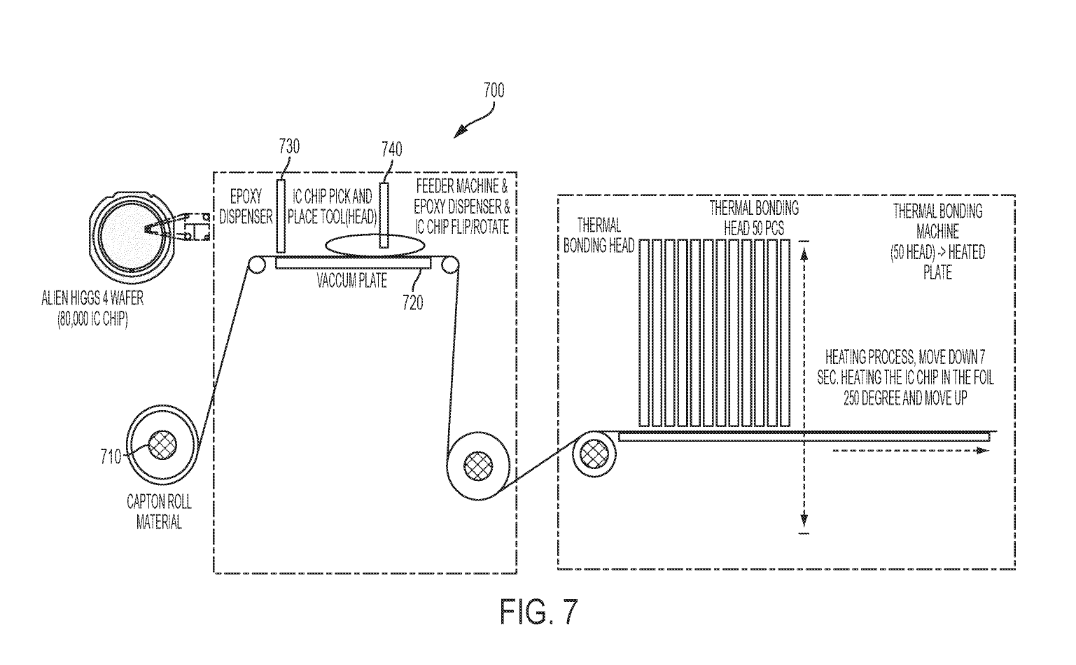

At step 360, after drying the antennas, foil 405 is loaded into bonding unit 700 of FIG. 7 through caster 710 on vacuum plate 720. The bonding unit 700 is preferably integrated with the feeding unit 400, printing unit 500, and multi-chamber drying unit 600, but the units can be separated.

At step 370, epoxy resin dispenser 730 dispenses epoxy resin on foil 405.

At step 380, IC chip pick and place tool 740 mount UHF RFID IC chip 120 to foil 405 by connecting IC chip 120 to antennas 107 and 108 with epoxy resin.

At step 390, thermal bonding head 750 provides heat at 225-275, and preferably 250 degrees Celsius for 6-10 and preferably 8 seconds to foil 405 to cure the epoxy resin and fix the RFID IC 120 to foil 405.

At step 395, foil 405 is encased by the first flexible substrate 102 and second flexible substrate 106, sealed, and cut to desired dimensions to create RFID tag 100.

RFID tag 100 can be used with different types of readers for a wide variety of applications. It is waterproof and made of materials able to withstand high pressure, hot and cold temperatures, and durable enough be used in a wide variety of applications, including being attached affixed, to, woven in, or otherwise enclosed within clothing, towels, linen, or other laundry that is washed in washing machines, or affixed to other products, including consumer products, food products, and other goods and inventory. Such tags are capable of reuse in certain applications.

For example, RFID tag 100 can be used with a mobile (Ultra High Frequency) UHF reader that can scan up to 150 tags per second at a range of up to 4 meters. The mobile reader contains an interface that can connect with smartphones or tablets without modifying the reader using Bluetooth and other forms of wireless communication. It preferably uses an octagonal shaped kapton/polymide flexible foil antenna.

RFID tag 100 also can be used with a smart case reader such as those generally known to persons skilled in the art. RFID tag 100 also can be used with a gate reader designed for retail environments that includes one or two pieces of asynchronously connected UHF RFID reader modules and 2 to 8 pieces of 1000 mm×500 mm flexible polyester antennas, with an outer case made from carbon fiber and glass fiber alloy capable of shielding and diverting the attention of radio waves. It can scan up to 950 tags per second in a range of up to 10 meters.

RFID tag 100 also can be used with the specific RFID smart phone case designed described herein below.

RFID Reader Smart Phone Case

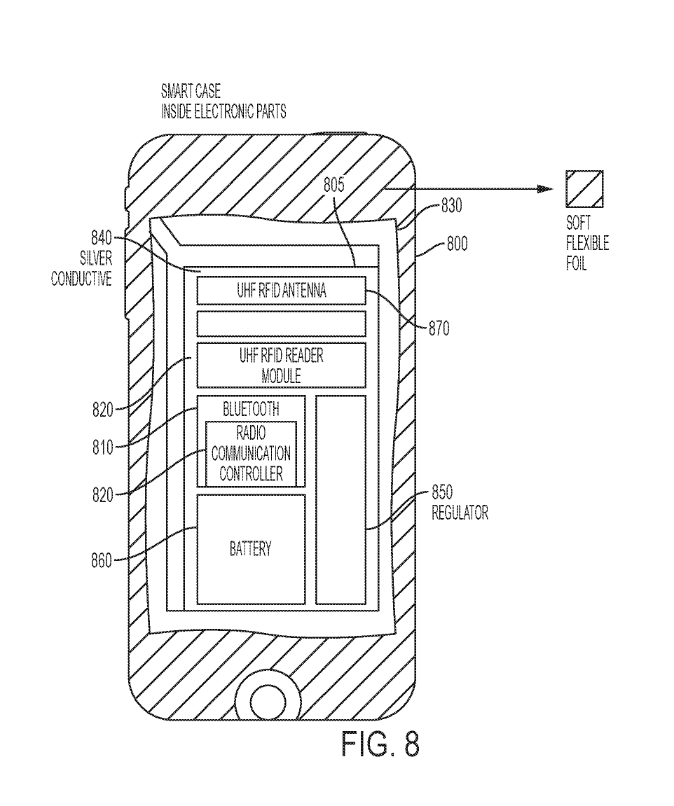

FIG. 8 depicts a schematic view of an electrical panel 805 for a smart phone case 800. The electrical panel 805 is equipped with a bluetooth radio communication controller 810 and RFID reader module (transmitter/receiver) 820, external battery 860, UHF flexible RFID antenna 870, and regulator 850. The bluetooth radio communication controller 810, RFID reader module 820 are installed on a flexible foil 830, which preferably links the electrical panel 805 components with silver conductive ink 840, which provides superior conductive properties and corrosion resistance. The case 800 is preferably coated externally with polyurethane rubber, which has superior isolation capabilities.

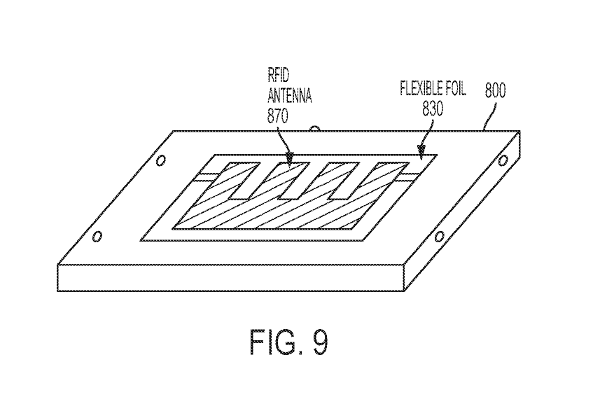

FIG. 9 depicts a hollowed out perspective view of the case 800 that depicts the UHF antenna 870 on flexible foil 830.

The case 800 can be used to read RFID tag 100 made as described herein, but also can read each and every other RFID tag built according to RAIN RFID promoted standards, including ISO/IEC 18000-63 and GSI EPC™ UHF Gen 2, regardless of whether such tags are made as described herein or regardless of whether the tags have a dipole antenna. The case can read tags located within 3 meters or less of the case 800. The case 800 is designed to be able to communicate with, charge, and be operable with software on smart phones using Android or IOS operating system or other operating systems. The phone holder part of the case is replaceable, so the case 800 can be designed to work with different smart phone models.

The case 800 is capable of locating, tracking, and monitoring specific RFID tags, including RFID tag 100, as well as items are equipped with RFID tags embedded or attached using the UHF reader module (transmitter/receiver) 820 and UHF flexible RFID antenna 870. A network of multiple smart phone cases 800 can be used and smart phones connected to the cases can detect/track real time RFID tags in the network and smart phone case 800 is configured and programmed to communicate location, monitoring, and tracking data to a computer or smart phone connected to the smart phone case using data communication systems of the smart phones and the case 800.

Smart RFID Cabinet

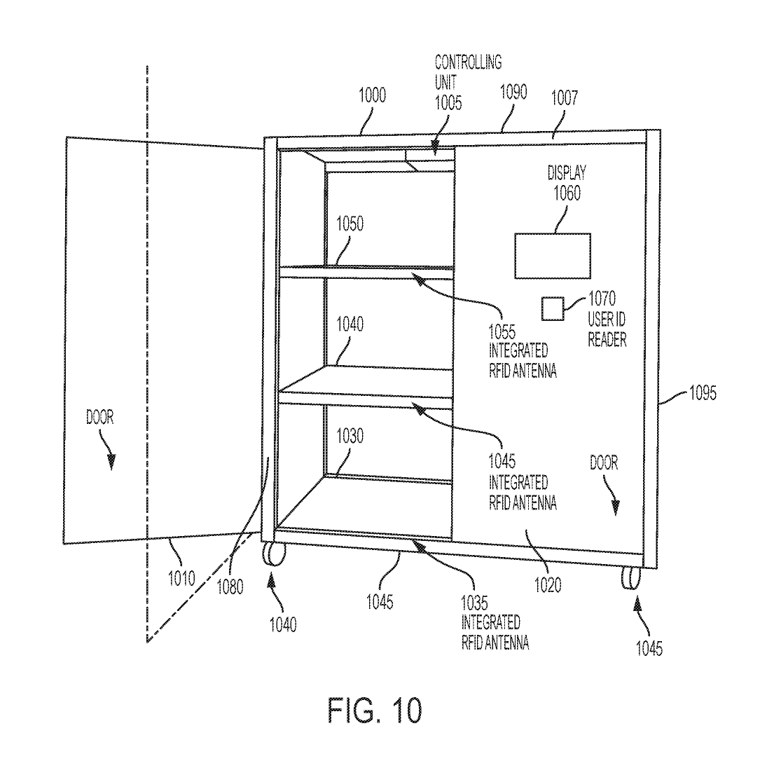

FIG. 10 depicts a smart RFID cabinet 1000 in a front view with doors 1010 and 1020, with door 1010 open to reveal connected shelves 1030, 1040, and 1050. Although two doors 1010 and 1020 are depicted, a greater or fewer number of doors can be used. Similarly, although three shelves are depicted, a greater or fewer number of shelves could be used. Each of the shelves 1030, 1040, and 1050 have integrated therein RFID antennas 1035, 1045, and 1055 configured to detect RFID tags, such as RFID tag 100 that are paired with the integrated RFID antennas 1035, 1045, and 1055.

The shelves 1030, 1040, and 1050 are made of a glass fiber material coated with a carbon alloy material layer to improve the ability of the integrated RFID antennas and permit RFID signals to pass through them and better control the RF wave throughput to enable shelves to be read separately without cross shelf interference. The doors 1010 and 1020 are made of metal, preferably aluminum and inox steel, as are the sides 1080 and 1085 and top surface 1090, rear panel (not depicted) and bottom surface 1095 of the cabinet 1000. The doors 1010 and 1020 contain an electronic lock and proximity sensors (not depicted) that signal that the doors are open, closed, or locked.

There is an optional sized display 1060, which serves as an interface items with RFID tags in the cabinet 1000 and user ID reader 1070 to open the doors 1010 and 1020 of the cabinet 1000. The cabinet 1000 can also optionally include wheels 1040 and 1045 to make cabinet 1000 mobile.

The cabinet contains a controlling unit 1005, comprising a uninterruptable power supply (UPS), a controlling computer (not depicted) with memory and the necessary cables that connect the modules to each other. The cabinet 1000 is capable to hold as many as 150 items having RFID tags integrated therein on each shelf.

The outputs can be controlled separately. Items containing RFID tags placed on separate shelves such that the stored items can be identified and scanned separately. Other items on a shelf or shelves that are above or below a specific shelf will not affect the ability to track a specific item on or to a specific shelf.

There is a high performance lithium polymer battery 1007 connected to the controlling unit 1005. That means a cart can be movable during the logistics processes along with the items that are (RFID tagged) stored inside the cabinet. The UPS ensures operation during transportation that makes possible to track in transit items. The cabinet controlling unit 1005 can be programmed and configured so that the doors 1010 and 1020 will not open without providing proper identification to the user ID reader 1070. For example, people who have not returned scrubs to cabinet 1000 may be denied access to obtain additional scrubs until scrubs previously taken from the cabinet 1000 have been returned, based upon policies programmed into the cabinet controlling unit 1005 controlling computer.

The cabinet can be used to track, inventory, and control access and use of a wide variety of items that can have RFID tags attached or embedded, such as the RFID tags described above embedded in the, such as work uniforms, towels, and hospital scrubs, office supplies. The cabinet 1000 can be configured and programmed in a variety of ways. It can determine when items are taken from the cabinet 1000 and when they are returned, as well as when they are not returned. Each time an item is removed or returned to the cabinet transaction can be tracked and recorded and stored in memory of the cabinet controlling unit 1005 controlling computer and communicated to a computer, the cabinet, or a smartphone. Access to the cabinet is controlled through the user ID reader 1070.

The inventions have been described herein in terms of particular embodiments. Alternatives described herein are examples for illustration only and not to limit the alternatives in any way. Certain steps of the invention can be performed in a different order and still achieve desirable results. It will be obvious to persons skilled in the art to make various changes and modifications to the invention described herein. To the extent that these variations depart from the scope and spirit of what is described herein, they are intended to be encompassed therein. It will be understood by those skilled in the art that various changes in form and details may be made therein without departing from the scope of the invention encompassed by the appended claims.

What is claimed is:

1. A smart phone charging case comprising:
an electrical panel installed on a flexible foil,
the electrical panel comprising:
a Bluetooth radio communication controller;
RFID reader module;
UHF flexible RFID antenna;
port to receive and charge a mobile phone;
and battery,
wherein the Bluetooth radio controller, the RFID reader module, the UHF flexible RFID antenna, and battery are connected using conductive ink.

2. The smart phone case of claim 1, wherein the smart phone case is configured and programmed to track, monitor, or locate in real time the RFID tags and items with RFID tags embedded or otherwise attached, including towels, uniforms, clothing items, scrubs, or office supplies and communicate tracking, monitoring, or location information for the RFID tags and items with RFID tags embedded or otherwise attached to a computer or smartphone.

3. The smart phone case of claim 2, wherein the smart phone case reads the RFID tags or the items with RFID tags embedded or otherwise attached located within a distance of 3 meters or less of the smart phone case.

4. The smart phone case of claim 4, wherein the smart phone case is configured and programmed to communicate the location, monitoring, and tracking data for the RFID tags or the items with RFID tags embedded or otherwise attached to a smart phone connected to the smart phone case.

5. The smart phone case of claim 4, wherein the smart phone case is a first smart phone case configured and programmed to be connected and linked with one or more additional smart phone cases each comprising:
an electrical panel installed on a flexible foil,
the electrical panel comprising
a Bluetooth radio controller;
RFID reader module;
UHF flexible RFID antenna;
port to receive and charge a smartphone configured and programmed to locate, monitor, and track in real time RFID tags and items with RFID tags embedded or otherwise attached, including towels, uniforms, clothing items, scrubs, and office supplies;
and a battery,
wherein the additional smartphone charging cases are configured and programmed to locate, monitor, and track in real time RFID tags and items with RFID tags embedded or otherwise attached connected to the additional smart phone cases, including towels, uniforms, clothing items, scrubs, and office supplies, paired with the additional smart phone cases, and the first smart phone case is configured and programmed to locate, monitor and track the RFID tags and items with RFID tags embedded or otherwise attached, connected to or paired with either the first smart phone case, the additional smart phone cases, or both the first smart phone case, and the additional smart phone cases.

6. The smart phone case of claim 4, wherein the smart phone case is coated in polyurethane rubber.

7. A method of tracking, locating, or monitoring RFID tags and items with RFID tags embedded or otherwise attached comprising:
providing a smart phone charging case comprising:
an electrical panel installed on a flexible foil,
the electrical panel comprising a Bluetooth radio communication controller, RFID reader module, UHF flexible RFID antenna, port to receive and charge a mobile phone, and battery,
wherein the Bluetooth radio controller, the RFID reader module, the UHF flexible RFID antenna, and battery are connected using conductive ink;
using the smart phone charging case to track, monitor, or locate RFID tags and items with RFID tags embedded or otherwise attached;
using the smartphone charging case to track, monitor, or locate RFID tags or items with RFID tags embedded or otherwise attached;
communicating tracking, monitoring, or location information for the RFID tags or RFID tags and the items with RFID tags embedded or otherwise attached from the smart phone charging case to a computer or a smartphone.

8. A cabinet comprising:
a controlling unit comprising a controlling computer having memory
two or more shelves in electronic communication connected by a top surface and bottom surface;
and a lithium battery,
wherein each of the shelves comprise glass fiber coated with carbon alloy material and have integrated RFID antennas, wherein the integrated antennas and the controlling computer are configured, paired, or connected with RFID tags or items with RFID tags embedded or otherwise attached located on the shelves, wherein the cabinet is configured or programmed to track, monitor, or locate the RFID tags or the items with RFID tags embedded or otherwise attached located on the shelves and communicate tracking, monitoring, or location information for the RFID tags or items with RFID tags embedded or otherwise attached to a computer or smartphone.

9. The cabinet of claim 8, wherein the top surface and the bottom surface comprise metal and the RFID tags or items with RFID tags embedded or otherwise attached are located on the shelves and the cabinet is configured and programmed to locate, monitor and track in real time when the RFID tags or items with RFID tags embedded or otherwise attached are removed from a specific shelf and returned to the specific shelf.

10. The cabinet of claim 9, wherein the cabinet is configured and programmed to locate, monitor and track in real time when the RFID tags or items with RFID tags embedded or otherwise attached are RFID tags or items with RFID tags embedded or otherwise attached are removed from any shelf in the cabinet and returned to any of the shelves in the cabinet.

11. The cabinet of claim 9, wherein the cabinet is configured and programmed so that presence or absence of the RFID tags or the items with RFID tags embedded or otherwise attached on shelves other than the specific shelf do not interfere with or affect locating, monitoring and tracking in real time when the RFID tags or items with RFID tags embedded or otherwise attached are removed from the specific shelf and returned to the specific shelf.

12. The cabinet of claim 10, wherein the cabinet is configured and programmed so that presence or absence of the RFID tags or the items with RFID tags embedded or otherwise attached on shelves other than the specific shelf do not interfere with or affect locate, monitoring and tracking in real time when the RFID tags or items with RFID tags embedded or otherwise attached are removed from any shelf in the cabinet and returned to any of the shelves in the cabinet.

13. The cabinet of claim 9, wherein the cabinet further comprises one or more doors and an ID reader, where the doors comprise aluminum or inox steel and remain closed unless the RFID reader is presented with a card or code configured or programmed to open the one or more doors.

14. The cabinet of claim 10, wherein the cabinet further comprises one or more doors and an ID reader, where the doors comprise aluminum or inox steel and remain closed unless the RFID reader is presented with a card or code configured or programmed to open the one or more doors.

15. The cabinet of claim 11, wherein the cabinet further comprises one or more doors and an ID reader, where the doors comprise aluminum or inox steel and remain closed unless the RFID reader is presented with a card or code configured or programmed to open the one or more doors.

16. The cabinet of claim 12, wherein the cabinet further comprises one or more doors and an ID reader, where the doors comprise aluminum or inox steel and remain closed unless the RFID reader is presented with a card or code configured or programmed to open the one or more doors.

17. The cabinet of claim 8, further comprising a monitor in electronic communication with the cabinet and any RFID tags or items having RFID tags attached or embedded that are stored in the cabinet and presents on the monitor tracking, monitoring or location information on the RFID tags or items having RFID tags attached or embedded that are stored in the cabinet and stores the tracking, monitoring, or location information in the controlling unit computer memory.

18. A method of locating, tracking, and monitoring RFID tags or items with RFID tags embedded or otherwise attached comprising:
placing RFID tags or items with RFID tags embedded or otherwise attached, including towels, uniforms, clothing items, scrubs, and office supplies on a shelf of a cabinet comprising a controlling unit comprising a controlling computer, two or more shelves in electronic communication connected by a top surface and bottom surface, and a high performance lithium battery, wherein each of the shelves comprise glass fiber coated with carbon alloy material and integrated RFID antennas;
pairing or connecting the RFID tags or items with RFID tags embedded or otherwise attached with the controlling computer of the cabinet;
locating, monitoring or tracking the RFID tags or items with RFID tags embedded or otherwise attached with the cabinet;
storing location, monitoring, or tracking information for the RFID tags or items with RFID tags embedded or otherwise attached in memory; and
communicating the location, monitoring, or tracking information to a computer, smartphone, or a monitor of the cabinet.

19. In combination, the smart phone case of claim 4 and RFID tags comprising:
a first substrate carrier comprising a flexible waterproof material and configured to include a substrate carrier foil comprising at least a first antenna printed on the substrate carrier foil from a conductive ink liquid solution;
at least first and second resonance amplifiers printed on the substrate carrier foil and connected to the at least first antenna;
a UHF RFID circuit integrated into the substrate carrier foil at the first antenna; and
a second substrate carrier comprising a flexible waterproof material configured to cover the first substrate carrier and the UHF RFID circuit,
wherein the substrate carrier foil comprises kapton and the first antenna has a length of 5 to 255 mm, a width of 0.005 to 5 mm, and a thickness of 0.05 to 9 nm, wherein the conductive ink solution comprises 65-75% DuPont e782 Silver ink, 15-25% graphite, and 5-15% neodymium.

20. In combination, the smart phone case and the RFID tags of claim 19, wherein wherein the substrate carrier foil of the RFID tags comprises ST505 PET polymide and polyester.

21. The smart phone case and RFID tags of claim 20, wherein the substrate carrier foil of the RFID tags further comprises kapton laminate.

22. The smart phone carrier case and the RFID tags of claim 21, wherein the RFID tags comprise a second antenna printed on the substrate carrier foil from the conductive ink solution, wherein the second antenna has a length of 5 to 255 mm, a width of 0.005 to 5 mm, and a thickness of 0.05 to 0.9 nm, and the first antenna and the second antenna are symmetrically offset across a longitudinal centerline at at least four offset points, further comprising a third and fourth resonance amplifier, wherein the third and fourth resonance amplifiers are printed on the substrate carrier foil at two of the four offset points.

23. In combination, the cabinet of claim 8 and RFID tags comprising:
a first substrate carrier comprising a flexible waterproof material and configured to include a substrate carrier foil comprising at least a first antenna printed on the substrate carrier foil from a conductive ink liquid solution;
at least first and second resonance amplifiers printed on the substrate carrier foil and connected to the at least first antenna;
a UHF RFID circuit integrated into the substrate carrier foil at the first antenna; and
a second substrate carrier comprising a flexible waterproof material configured to cover the first substrate carrier and the UHF RFID circuit,
wherein the substrate carrier foil comprises kapton and the first antenna has a length of 5 to 255 mm, a width of 0.005 to 5 mm, and a thickness of 0.05 to 9 nm, wherein the conductive ink solution comprises 65-75% DuPont e782 Silver ink, 15-25% graphite, and 5-15% neodymium.

24. The cabinet and RFID tags of claim 23 wherein the RFID tags further comprise a second antenna printed on the substrate carrier foil from the conductive ink solution, wherein the second antenna has a length of 5 to 255 mm, a width of 0.005 to 5 mm, and a thickness of 0.05 to 0.9 nm and the first antenna and the second antenna are symmetrically offset across a longitudinal centerline at at least four offset points, further comprising a second resonance amplifier, wherein the first and second resonance amplifiers are printed on the first substrate carrier foil at the four offset points.

25. In combination, the cabinet of claim 9 and RFID tags comprising:
a first substrate carrier comprising a flexible waterproof material and configured to include a substrate carrier foil comprising at least a first antenna printed on the substrate carrier foil from a conductive ink liquid solution;
at least first and second resonance amplifiers printed on the substrate carrier foil and connected to the at least first antenna;
a UHF RFID circuit integrated into the substrate carrier foil at the first antenna; and
a second substrate carrier comprising a flexible waterproof material configured to cover the first substrate carrier and the UHF RFID circuit,
wherein the substrate carrier foil comprises kapton and the first antenna has a length of 5 to 255 mm, a width of 0.005 to 5 mm, and a thickness of 0.05 to 9 nm, wherein the conductive ink solution comprises 65-75% DuPont e782 Silver ink, 15-25% graphite, and 5-15% neodymium.

26. The cabinet and RFID tags of claim 25, wherein the RFID tags further comprise a second antenna printed on the substrate carrier foil from the conductive ink solution, wherein the second antenna has a length of 5 to 255 mm, a width of 0.005 to 5 mm, and a thickness of 0.05 to 0.9 nm and the first antenna and the second antenna are symmetrically offset across a longitudinal centerline at at least four offset points, further comprising a second resonance amplifier, wherein the first and second resonance amplifiers are printed on the first substrate carrier foil at the four offset points

27. In combination, the cabinet of claim 10 and RFID tags comprising:
a first substrate carrier comprising a flexible waterproof material and configured to include a substrate carrier foil comprising at least a first antenna printed on the substrate carrier foil from a conductive ink liquid solution;
at least first and second resonance amplifiers printed on the substrate carrier foil and connected to the at least first antenna;
a UHF RFID circuit integrated into the substrate carrier foil at the first antenna; and
a second substrate carrier comprising a flexible waterproof material configured to cover the first substrate carrier and the UHF RFID circuit,
wherein the substrate carrier foil comprises kapton and the first antenna has a length of 5 to 255 mm, a width of 0.005 to 5 mm, and a thickness of 0.05 to 9 nm, wherein the conductive ink solution comprises 65-75% DuPont e782 Silver ink, 15-25% graphite, and 5-15% neodymium.

28. The cabinet and RFID tags of claim 27, wherein the RFID tags further comprise a second antenna printed on the substrate carrier foil from the conductive ink solution, wherein the second antenna has a length of 5 to 255 mm, a width of 0.005 to 5 mm, and a thickness of 0.05 to 0.9 nm and the first antenna and the second antenna are symmetrically offset across a longitudinal centerline at at least four offset points, further comprising a second resonance amplifier, wherein the first and second resonance amplifiers are printed on the first substrate carrier foil at the four offset points.

29. In combination, the cabinet of claim 11 and RFID tags comprising:
a first substrate carrier comprising a flexible waterproof material and configured to include a substrate carrier foil comprising at least a first antenna printed on the substrate carrier foil from a conductive ink liquid solution;
at least first and second resonance amplifiers printed on the substrate carrier foil and connected to the at least first antenna;
a UHF RFID circuit integrated into the substrate carrier foil at the first antenna; and
a second substrate carrier comprising a flexible waterproof material configured to cover the first substrate carrier and the UHF RFID circuit,
wherein the substrate carrier foil comprises kapton and the first antenna has a length of 5 to 255 mm, a width of 0.005 to 5 mm, and a thickness of 0.05 to 9 nm, wherein the conductive ink solution comprises 65-75% DuPont e782 Silver ink, 15-25% graphite, and 5-15% neodymium.

30. The cabinet and RFID tags of claim 29, wherein the RFID tags further comprise a second antenna printed on the substrate carrier foil from the conductive ink solution, wherein the second antenna has a length of 5 to 255 mm, a width of 0.005 to 5 mm, and a thickness of 0.05 to 0.9 nm and the first antenna and the second antenna are symmetrically offset across a longitudinal centerline at at least four offset points, further comprising a second resonance amplifier, wherein the first and second resonance amplifiers are printed on the first substrate carrier foil at the four offset points.

31. In combination, the cabinet of claim 12 and RFID tags comprising:
a first substrate carrier comprising a flexible waterproof material and configured to include a substrate carrier foil comprising at least a first antenna printed on the substrate carrier foil from a conductive ink liquid solution;
at least first and second resonance amplifiers printed on the substrate carrier foil and connected to the at least first antenna;
a UHF RFID circuit integrated into the substrate carrier foil at the first antenna; and
a second substrate carrier comprising a flexible waterproof material configured to cover the first substrate carrier and the UHF RFID circuit,
wherein the substrate carrier foil comprises kapton and the first antenna has a length of 5 to 255 mm, a width of 0.005 to 5 mm, and a thickness of 0.05 to 9 nm, wherein the conductive ink solution comprises 65-75% DuPont e782 Silver ink, 15-25% graphite, and 5-15% neodymium.

32. The cabinet and RFID tags of claim 31, wherein the RFID tags further comprise a second antenna printed on the substrate carrier foil from the conductive ink solution, wherein the second antenna has a length of 5 to 255 mm, a width of 0.005 to 5 mm, and a thickness of 0.05 to 0.9 nm and the first antenna and the second antenna are symmetrically offset across a longitudinal centerline at at least four offset points, further comprising a second resonance amplifier, wherein the first and second resonance amplifiers are printed on the first substrate carrier foil at the four offset points.
